(19) United States
(12) Patent Application Publication
(10) Pub. No.: US 2007/0260991 A1
(43) Pub. Date: Nov. 8, 2007

(54) METHOD AND DEVICE FOR PROVIDING MATCHED COMMUNICATION WINDOWS FOR COMMUNICATION WITH A COMMUNICATION PARTNER IN AN APPLICATION ON A TERMINAL OF A USER

(75) Inventors: Frank Schueler, Karlsruhe (DE); Christian Reissmueller, Sulzberg (DE)

Correspondence Address: DARBY & DARBY P.C., P.O. BOX 770, Church Street Station, New York, NY, 10008-0770, US

(73) Assignee: COMBOTS PRODUCT GMBH, Karlsruhe (DE)

(21) Appl. No.: 11/745,590

(22) Filed: May 8, 2007

(30) Foreign Application Priority Data
May 8, 2006 (DE) 10 2006 021 376.9

(51) Int. Cl. G06F 3/00

(52) U.S. Cl. 715/758; 715/810; 715/706

(57) ABSTRACT

A method and device for providing at least one matched communication window for communication with a communication partner in an application on a terminal of a user is provided. Depending on the call of a program function, either a first communication window having a particular size and a particular functionality, or a second communication window having a different size and at least a partially different functionality is displayed. In addition, the first or second communication window is displayed depending on a type of communication provided in the program function.

This application claims priority to German Patent Application No. DE 10 2006 021 376.9 filed May 8, 2006, the contents of which is hereby incorporated by reference as if set forth in its entirety.

The invention relates to a method and a device for providing matched communication windows for communication with a communication partner in an application on a terminal of a user.

### BACKGROUND

In traditional communication systems, it is frequently possible to choose from several types of communication such as an IM communication (IM: Instant Messaging), a voice communication, a file-transfer communication, etc. is available to the user. Depending on the chosen type of communication, it is desirable to send additional written messages to a communication partner. To this end, usually an IM communication window is additionally opened in order to enable the user to input the written messages. However, simply because of the size of the communication window and the wealth of functions relative to the loading time, in IM communication it is not always expedient to open such a communication window whenever additional written messages or files with e.g., images are also to be sent.

### SUMMARY

In an embodiment of the present invention, a method and device for providing at least one matched communication window for communication with a communication partner in an application on a terminal of a user is provided. Depending on the call of a program function, either a first communication window having a particular size and a particular functionality, or a second communication window having a different size and at least a partially different functionality is displayed. In addition, the first or second communication window is displayed depending on a type of communication provided in the program function.

### BRIEF DESCRIPTION OF THE DRAWINGS

Exemplary embodiments of the present invention are explained in more detail below with reference to the accompanying drawings, in which:

FIG. 1 illustrates a schematic view of a communication system with two terminals according to the present invention; and

FIG. 2-FIGS. 16a-d illustrate various representations of graphic displays of selection menus on a graphic user interface according to the present invention.

### DETAILED DESCRIPTION

One feature of an embodiment of the present invention makes available a method and a device wherein a communication window is flexibly provided which is matched to the current requirement of the user.

According to a first feature of the present invention, a method is provided for preparing matched communication windows for communication with a communication partner in an application on a terminal of a user. Depending on the call of a program function, either a first communication window with a first size and with a first functionality or a second communication window with a second size different from the first and with a second functionality at least partly different from the first is displayed.

The method according to an embodiment of the present invention makes it possible, depending on the call of the program function, to open a communication window matched in size and functionality to the program function or to the wishes of the user.

In an embodiment of the present invention, the first communication window can have a conversation area in which the entries of the communication partners are displayed and an input area, and the second communication window an input area and no conversation area.

In addition, either the first or the second communication window can be displayed depending on whether the called program function is a real-time application such as an Instant Messaging application or a telephone application.

The first or the second communication window can be displayed depending on what type of communication the program function contains. Possible types of communications include, but are not limited to, a voice communication, an image communication, a text communication, a file-transfer communication, or an animotion communication.

The first or the second communication window can be displayed depending on the operating function with which the selection of the program function is executed. The operating function can include, but is not limited to, operating functions such as mouse movement, a mouse click, a drag & drop operation, or a mouseover operation.

The first or the second communication window can be displayed depending on whether the call of the program function is executed by the user or by a further user connected to the terminal of the user. Depending on the call of the program function, a third communication window with operating elements for changing settings relating to the called program function can also be displayed.

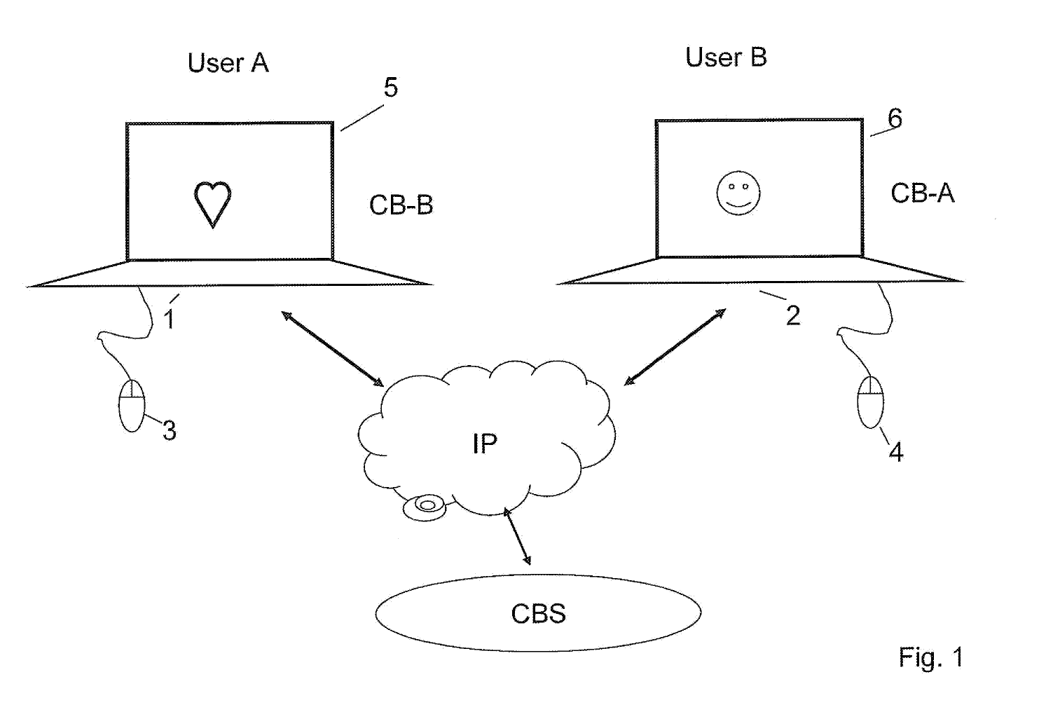

FIG. 1 shows a schematic view of a communication system having a control device CBS in which two communication partners, user A and user B, can exchange data via at least one network, such as the Internet IP, in order to communicate with each other in various ways. It is noted that instead of the Internet IP, other networks can also be used. The network nodes in the networks and also the end-points at the users (end-nodes) form a decentralized, organized network or the communication system. The transmission of data for the communication takes place via the various nodes which have essentially equal access and, depending on data flow, perform the function of a send, destination or transmission node. The control device CBS essentially manages the decentralized organization of the communication system, in particular, access to it by verifying the user authorization or authentication. The communication system integrates or connects transmission methods from store-and-forward or peer-to-peer and all possible types of communication. Possible types of communication include voice telephony, e-mail, IM (instant messaging), exchange of data of all types, the operation of file-sharing applications, whiteboard applications, and others.

For communication, each user has at his disposal a corresponding terminal 1, 2 which are shown here as PCs (personal computers). Other terminals 1, 2, such as mobile telephones, PDAs (personal digital systems) and similar with which a user can construct a data connection to the network IP in order to communicate via it, come into consideration as terminals 1, 2. The terminals 1, 2 can be connected to suitable input and output devices ideally having a telephone headset, a mouse 3, 4, a keyboard and a screen 5, 6. The communication system has at its disposal the central control device CBS which controls, monitors, supports and/or organizes the communication between the terminals of users A and B. To this end, the central control device CBS has at its disposal suitable software which can control access to the system and control the basic mechanisms of the connection set-up between terminal 1 and terminal 2 of the corresponding users A and B.

One feature of the communication system of the present invention is the graphic communication element, which can be operated by the user, which is referred to as a ComBOT™. ComBOT™ and ComBOTs™ are a trademark of ComBOTS Product GmbH. These communication elements are shown schematically in FIG. 1 and provided with the references CB-B and CB-A. A ComBOT™ is essentially an operable and animatable element (e.g., icon, symbol or figure) which, on the screen of terminal 1 of the respective communication partner user A, represents the contact with the other communication partner user B and via which a communication can be executed directly. Thus, in the embodiment of the present invention, on the screen of terminal 1 of user A there is a ComBOT™ CB-B which represents the other user B. Conversely, there is a ComBOT™ CB-A on the screen of terminal 2 of user B. The look and appearance of the ComBOT™ can be determined by each user, preferably the user who is represented by the respective ComBOT™. In the example shown here, user A is represented by a smiley and user B by a heart.

In terminals 1, 2, application software, such as client software, is run and connects to the central control unit CDB in particular to a server installed there. The client software carries out an authentication of the respective user A, B in the communication system. The user also performs certain functions via the ComBOTs™ and specifies parameters for the user that can preferably be stored in user profiles inside the central control device. Furthermore, signalling data are exchanged with the help of the client software which runs on the respective terminal 1, 2. This allows the central control device to control or at least prompt the construction of various transmission paths within the network for the transmission of the useful data required for communication.

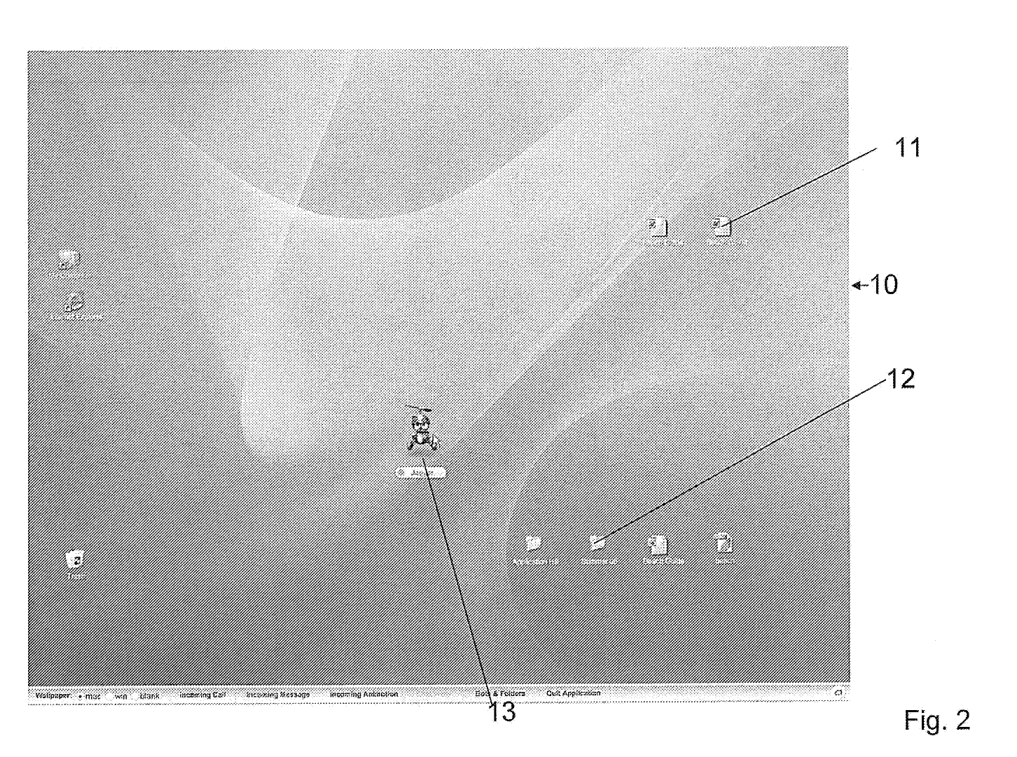

The running of the client software via an interaction with the ComBOT™ CB-B, CB-A, on the screen or display unit of the respective terminal is described in more detail below. To this end, the user's possibilities for interaction with a ComBOT™ displayed on his screen, which represents a further user as communication partner, are shown in FIGS. 2-14.

FIG. 2 shows a user interface or desktop of a conventional operating system in which symbols for files 11 and folders 12 are arranged on a background surface 10, i.e., a surface of the screen display which is not shown in a window. By double-clicking on the respective symbol 11, a user can open the file, executing it if an executable program file is involved or with a linked application if the file is a content file, such as a text file. By double-clicking on a symbol which represents a folder 12, a folder window is opened in which symbols for several files located therein, or further folders, are displayed which the corresponding user can execute or process in the manner described above.

Also located on the background surface, which is shown in FIG. 2, is a ComBOT™ 13 which in the shown embodiment example is a figure with a propeller hat, called “propeller man” below. The propeller man is a ComBOT™ 13 for a second user, e.g., B, connected to terminal 1, 2 of the user A, with whom there is a communication connection. Displayed below the propeller man is a label with the name “Jagger”, which displays the name of communication partner B represented by the propeller man. The propeller man including the label optionally to be provided is thus the ComBOT™ 13 which represents the communication partner B “Jagger”.

The propeller man is preferably animated and performs a circular movement according to a first animation sequence, with the result that it serves to catch the eye on the background image. The animation of the ComBOT™ 13 can essentially be selected preferably by the communication partner to whom it corresponds, depending on the situation, and a static ComBOT™ 13 can also be selected depending on the currently available computing and/or storage capacity.

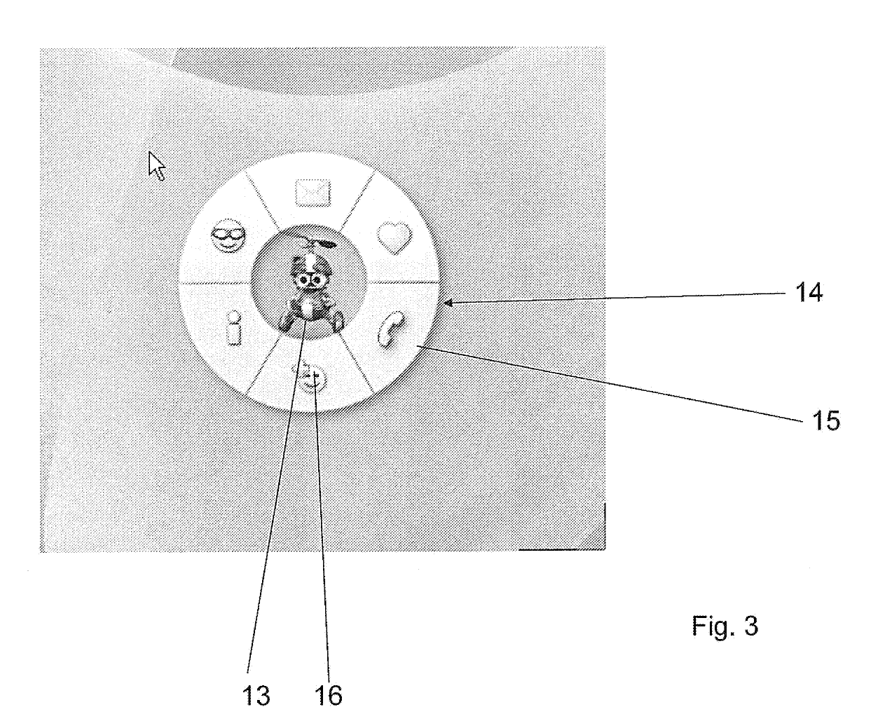

Functions that are executed by the client program which is allocated to ComBOT™ 13 can be activated in various ways. To gain access to these functions, a particular selection menu 14 or user menu, here called ComBOT™ menu, is opened by a suitable activation such as a left or right mouse click, controlled by the corresponding computer mouse 3, 4, on the ComBOT™ 13 (or on a symbol allocated to same), which allows a selection of various functions of the client program. An example of such a ComBOT™ menu 14 is shown in FIG. 3. The ComBOT™ menu 14 can also be opened by a mouse movement such as a mouseover which is executed via the relevant ComBOT™ 13 or in another spatial relationship to the position of ComBOT™ 13 on the display interface of the screen. Thus, for example, with the help of a circular movement when there are several ComBOTs™ located on the background image preferably around the ComBOT™ 13 to be selected, a ComBOT™ 13 can be selected and the selection menu or ComBOT™ menu 14 activated for a subsequent selection of a desired function, with the result that the ComBOT™ menu 14 is displayed on the background surface 10 of the screen.

The ComBOT™ menu 14 is preferably displayed enclosing the ComBOT™ 13 and has segments 15 which have selection elements 16. The ComBOT™ menu 14 is thus not only functional for the respective ComBOT™ 13, but also graphically directly allocated thereto. The selection elements 16 can be activated by clicking or by other actions. The ComBOT™ menu 14 enclosing ComBOT™ 13 can be ring-shaped, elliptical or also otherwise enclosing the ComBOT™ 13, with the result that the ComBOT™ 13 remains visible in the middle of the ComBOT™ menu 14 and the individual segments 15 with the selection elements 16 arranged therein in a group around the ComBOT™ 13. The ring-shaped ComBOT™ menu 14 has the advantage that a direct allocation of the menu to the corresponding ComBOT™ 13 is possible, with the result that, in particular when there is a larger number of different ComBOTs™ 13 which represent different communication partners, the ComBOT™ menu 14 clearly represents one of the communication partners. For example, the communication partner who corresponds to the ComBOT™ 13 displayed inside the ring-shaped ComBOT™ menu 14, in this case the propeller man, is clearly represented. In this manner, it is possible to have a clear allocation of the ComBOT™ menu 14 to the corresponding ComBOT™ 13 when several ComBOT™ menus 14 are open.

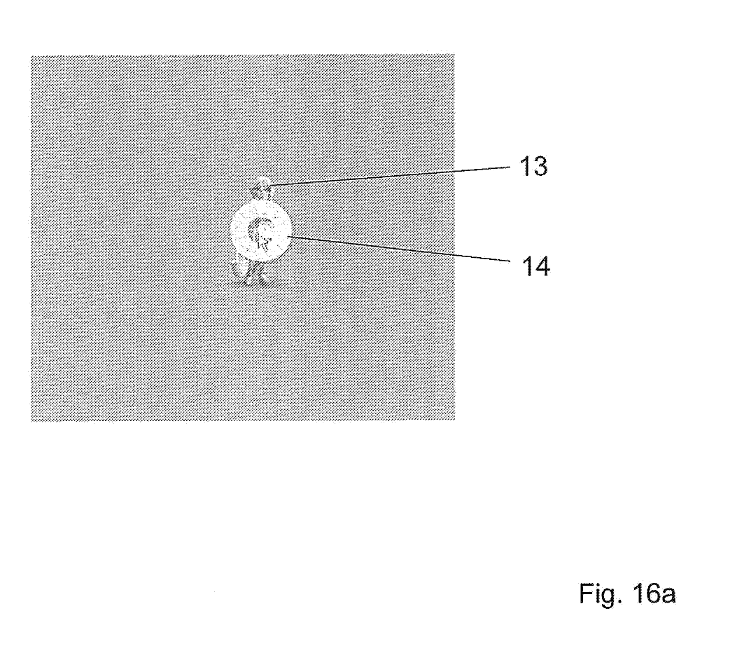

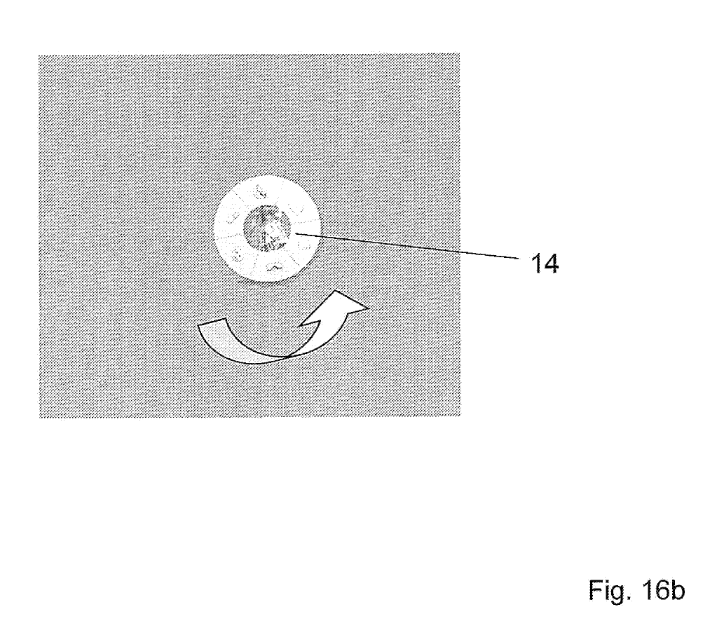

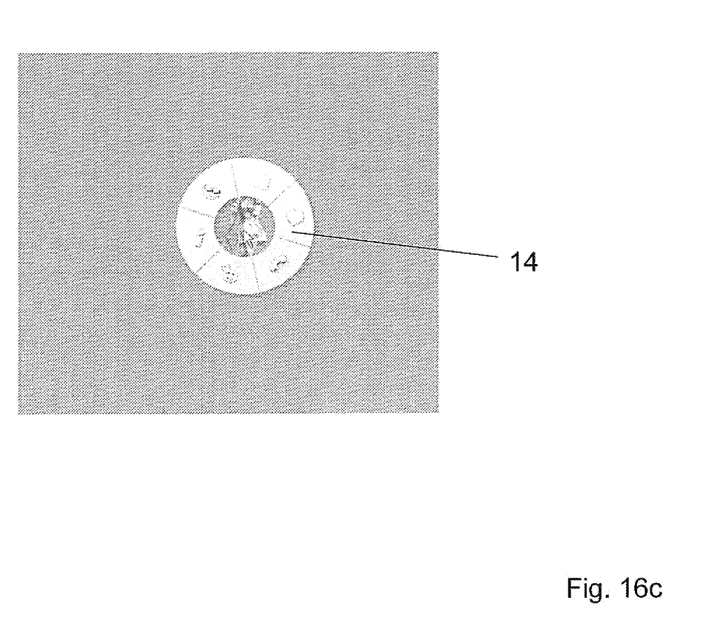

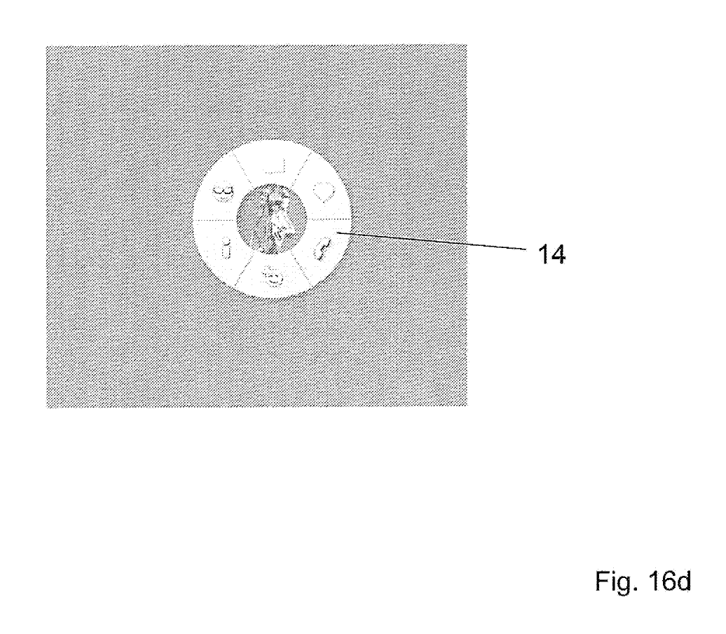

The ComBOT™ menu 14 appears by activating the ComBOT™ 13 in a manner as described above (e.g., clicking, mouse movement, keyboard shortcut, etc.) such that the ComBOT™ spirals outwards. The ring-shaped ComBOT™ menu 14 enlarges starting from the ComBOT™ 13 until it has reached its definitive size, and turns while doing so, with the result that the arrangement of the individual segments 15 and the selection elements 16 contained therein correspond to a predefined arrangement. This feature is also illustrated in FIGS. 16a to 16b, which show, by way of example in individual images, the progress or the sequence of a ComBOT™ menu 14 opening spirally around a ComBOT™ 13.

The ComBOT™ menu 14 can be deactivated when another function is executed on the background surface of the terminal, or when the ComBOT™ menu 14 of a ComBOT™ 13 representing a further communication partner is activated. The ComBOT™ menu 14 can also be deactivated by clicking, for example, on an empty part of the background surface 10. When the ComBOT™ menu 14 is deactivated, the ComBOT™ menu 14 preferably disappears in a manner similar to that in which it appeared, namely by spiralling in again, such as by turning and simultaneously shrinking until it disappears at the location of the ComBOT™ 13. When the ComBOT™ menu 14 is activated, the ComBOT™ 13 can execute a second animation sequence as further eye catcher which differs from the first animation sequence when the ComBOT™ menu 14 is deactivated.

The segments 15 of the ComBOT™ menu 14 are preferably ring segments in the shown embodiment example which completely enclose the ComBOT™ 13. Depending on the number of functions provided for the client program, the ring segments 15 can be enlarged and reduced, and the ComBOT™ menu 14 can also comprise several rings with respective segments 15 which are arranged concentrically beside each other around the corresponding ComBOT™ 13.

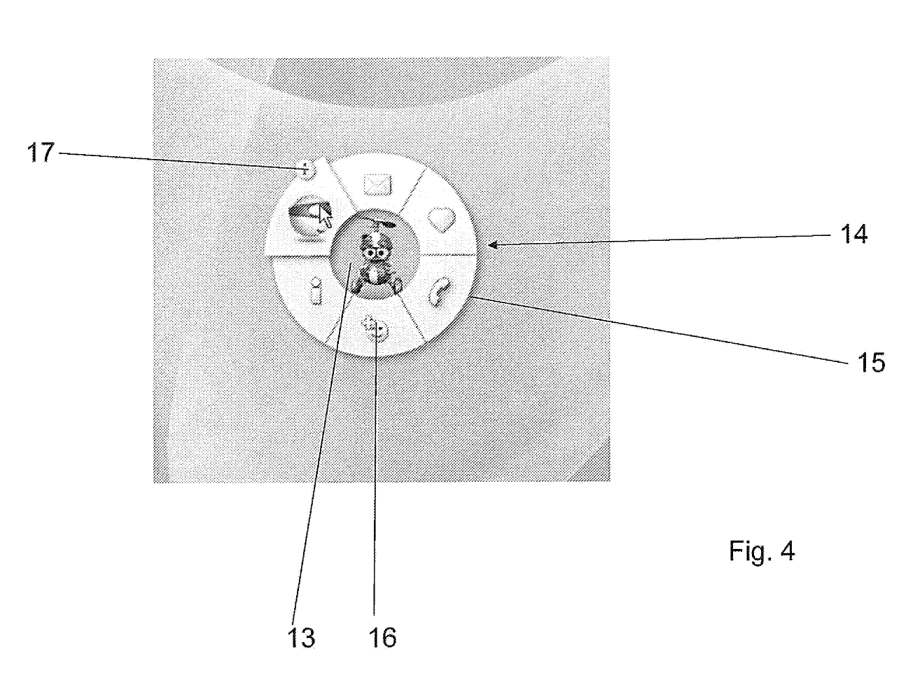

As shown in FIG. 4, as soon as the mouse pointer is moved over a segment 15 of the ring-shaped ComBOT™ menu 14, the respective segment 15 stands out. In the example, it is displayed enlarged and/or can be arranged offset vis-à-vis the original position of the segment 15. Furthermore, the colors of the selection element 16 displayed in the segment 15 can change, with the result that it is easily recognizable that a function allocated to the selection element 16 can be activated by clicking or other actions. The selection element 16 can be static or animated, in order to direct the attention of the user to the segment 15 of the ComBOT™ menu 14 that has been selected in this way. When one of the segments 15 of the ComBOT™ menu 14 is highlighted, the segment 15 can also be provided with an information selection element 17 which, in this example, is circular and is located on an outer edge of the respective segment and contains a symbol “i”, which represents help menus or information. If the mouse pointer now moves from the activated segment to the information selection element 17 according to a mouseover function or other action, either a textbox can immediately appear which contains help information, or a further menu with selectable functions can be activated, or a help film sequence can be displayed to explain the selection element 16 to which the information selection element 17 belongs. Both the activation of a segment of the ComBOT™ menu 14 and the activation of the information selection element 17 can be “commented” with a changed animation of the ComBOT™ 13 displayed inside the ring-shaped ComBOT™ menu 14. In particular, upon activation of the information selection element 17, the animation of the ComBOT™ 13 can back up or supplement the explanation of the function of the segment 15 of the ComBOT™ menu 14 that is allocated to the information selection element 17.

In an embodiment according to the present invention, a selection element 16 of the ComBOT™ menu 14 makes available, for example, a telephone function which is displayed as a telephone receiver symbol in a corresponding segment 15 of the ComBOT™ menu 14. If the mouse pointer is moved to the telephone receiver symbol and then to the information symbol “i”, the animation of the ComBOT™ 13 inside the ring-shaped ComBOT™ menu 14 can change and the latter displays, for example, dialling a telephone and holding a receiver to his head, with the result that a user is shown the function of the segment 15 of the ComBOT™ menu 14 as an animation. Thus, foreign-language users can also be helped via the information selection element 17.

In particular, the ring-shaped ComBOT™ menu 14 allows for a permanent allocation of the ComBOT™ menu 14 to the respective ComBOT™ 13. This provides the benefit that irrespective of the number of selection elements or menu items 16 to be provided, a clear allocation to the communication partner represented by the ComBOT™ 13 can take place.

If a segment 15 of the ComBOT™ menu 14 is connected to further subfunctions, these subfunctions can be displayed as a ComBOT™ submenu, which can extend in a ring-shape as an additional ComBOT™ menu 14 or as a ring segment around the already displayed ComBOT™ menu 14, and can have further segments which are each linked to the specific subfunctions.

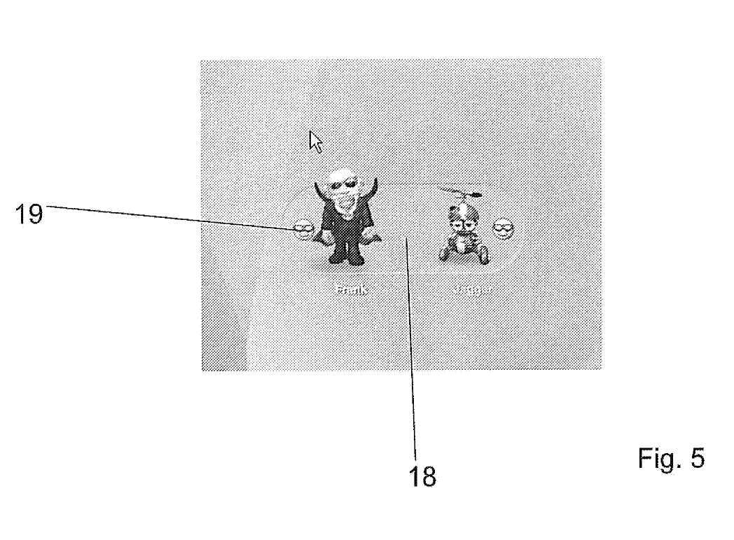

As shown in FIG. 5, a synopsis of the participating ComBOTs™, a so-called arena 18, can be opened or displayed in which both the ComBOT™ 13, which represents the user of the current terminal, in this case “Frank”, who is displayed as a ComBOT™ figure “Dracula”, and the ComBOT™ 13, which shows the communication partner “Jagger” as propeller man allocated to the activated ComBOT™ 13. The two ComBOTs™ “Dracula” and “propeller man” participating in the communication are located inside a graphically delimited zone, called arena 18, which is displayed in a different color or by a suitable border around the two ComBOTs™ 13.

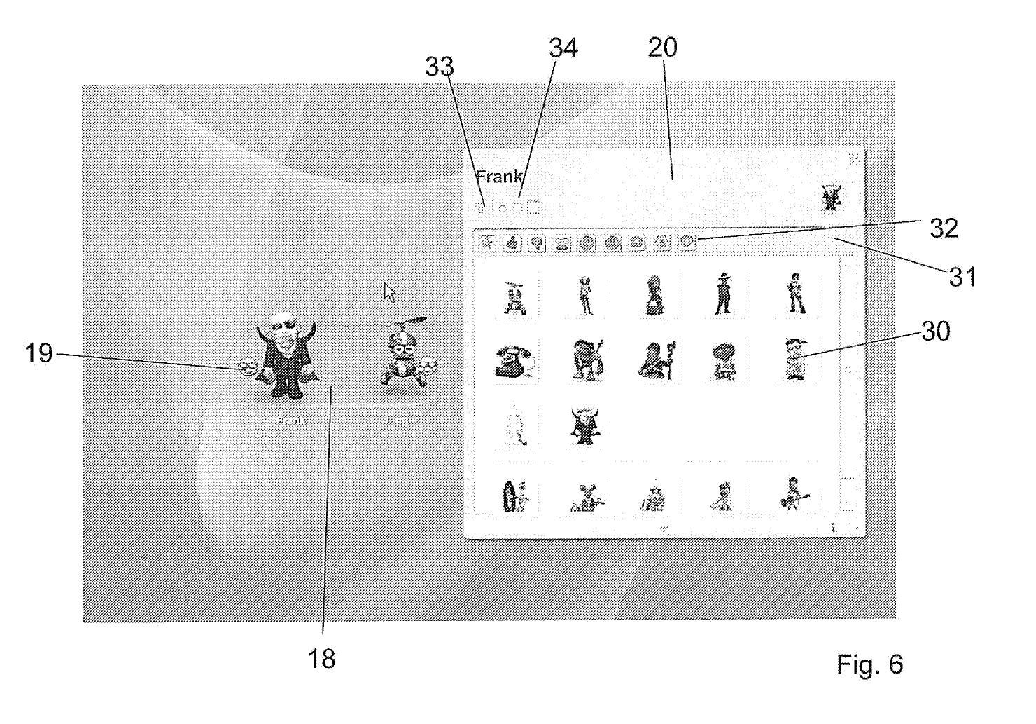

Beside each of “Frank”'s ComBOT™ “Dracula” and “Jagger”'s ComBOT™ “propeller man” a smiley symbol 19 is displayed with which, as is shown in FIG. 6, a selection menu in the form of a grid can be opened by clicking, the image of the ComBOT™ allocated to the smiley being able to be changed in the arena 18. Depending on which ComBOT™ smiley is activated, the image of the current user of the terminal or the image of the communication partner “Jagger” can be changed.

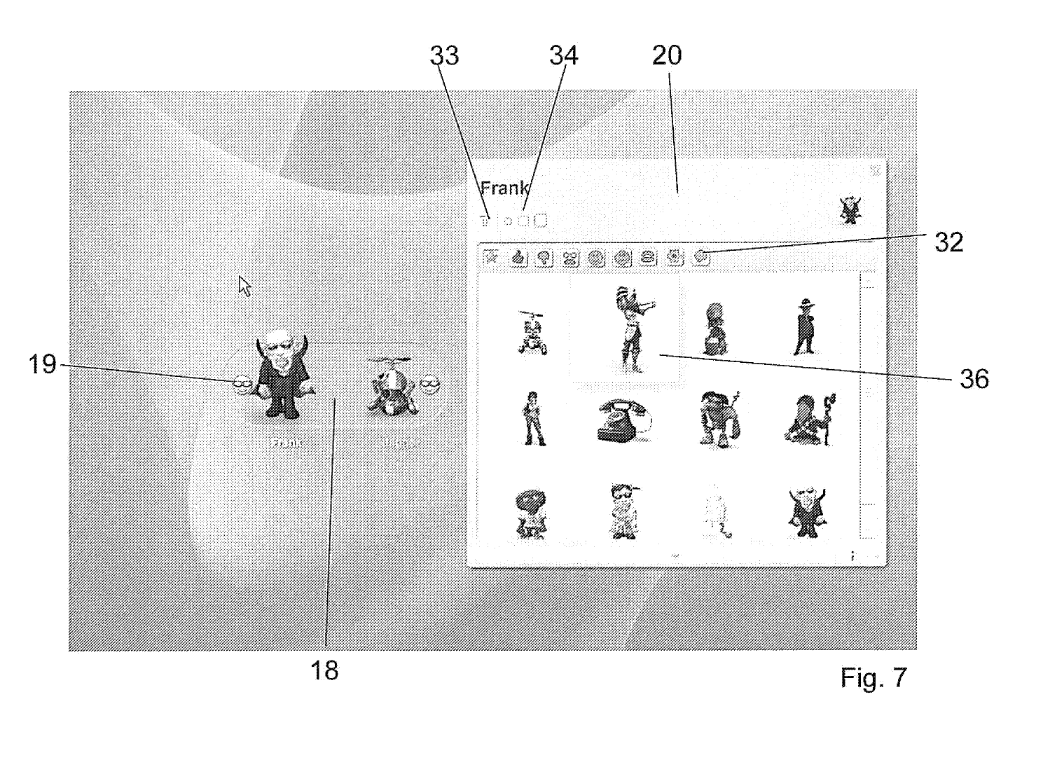

The selection menu 20 displays a number of different ComBOT™ image forms 30 which are predefined but can also partly be defined by the user. Furthermore, ComBOT™ image forms 30 can be displayed which are not immediately available for selection, but can be obtained from a provider of such ComBOT™ image forms. In a header area 31, the nature of the respective ComBOT™ image can firstly be selected via a suitable header element 32, and the respective ComBOT™ image form to be selected can then be selected by moving the mouse pointer over the ComBOT™ image forms displayed in a grid. Once the mouse pointer moves over the ComBOT™ image form, the latter is enlarged and highlighted (FIG. 7, reference number 36), with the result that the user can review his choice before making his selection. It is furthermore provided that the ComBOT™ image 30 over which the mouse pointer is located is displayed with an animation.

A text-selection element 33 and one or more enlargement-adjustment elements 34 can also be provided. The text-selection element 33 serves to switch on or off the display of a text allocated to the ComBOT™ image, such as, for example, a name, a greeting or other information. The enlargement-adjustment elements 34 serve to adjust the size with which the ComBOT™ images 30 are displayed in the grid of the selection menu 20.

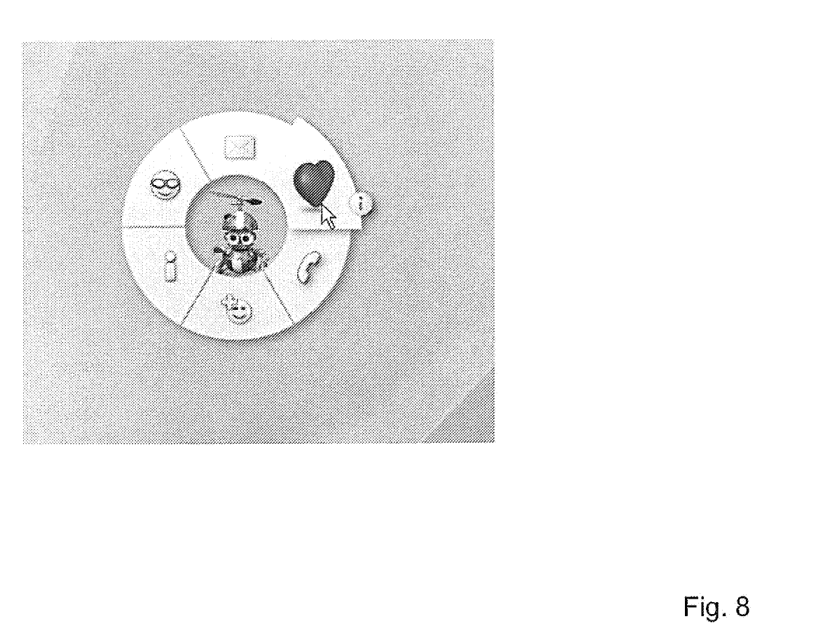

In an embodiment of the present invention, there is provided in the ComBOT™ menu 14 a further segment 15 which, in the shown example, is provided with a heart symbol (see FIG. 8) via which the connected communication partner can be sent a specific animation in order to establish a non-verbal communication. The communication partner, that of the relevant ComBOT™ 13 to which the ComBOT™ menu 14 is allocated, receives corresponding animation data which result in a specific animation of the ComBOT™ 13 allocated to the current user being executed on the background surface of the terminal of communication partner B. In other words, user A's ComBOT™ 13 executes on the background surface of user B's terminal an animation which user A has selected in order to communicate non-verbally with user B. This type of emotional communication executed for each animation is also called “animation” here.

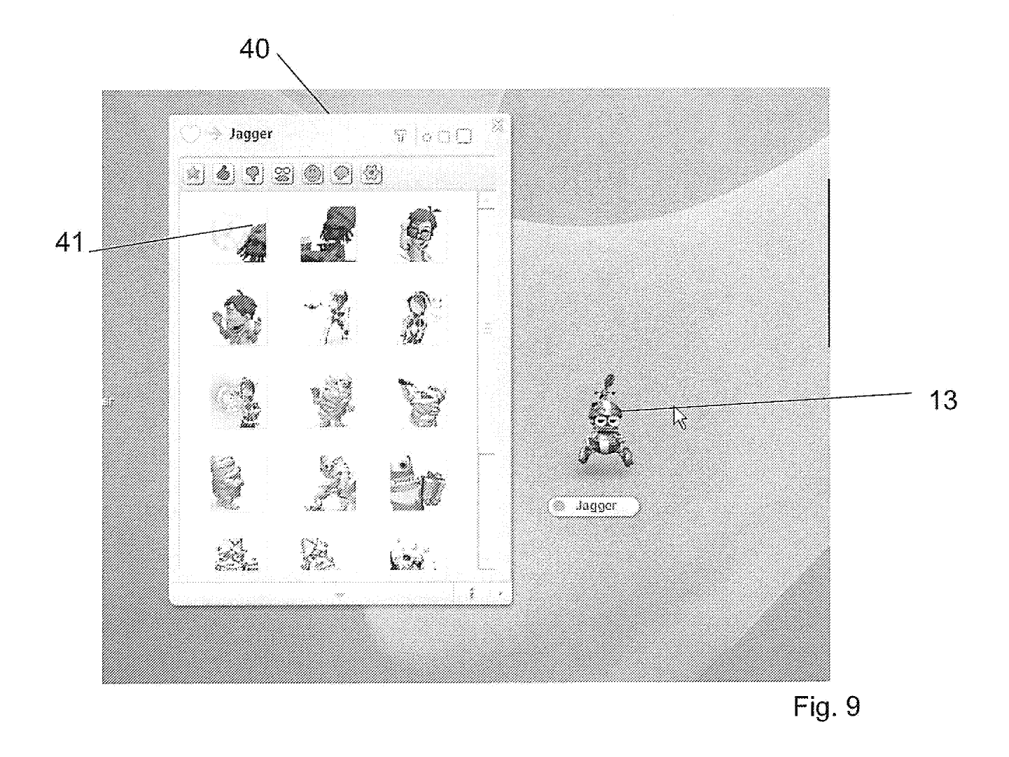

The animation or animotion is selected via a so-called animotion selection menu 40 which is shown by way of example in FIG. 9. The selection is carried out by displaying in one grid different animation symbols 41 which, when the mouse pointer moves over them in a mouseover function, are displayed enlarged and begin to execute the animation allocated to them. The animations can be divided into groups which can be selected through suitable header elements 42 in order to display animation symbols 41 for different emotions or information for the selection of the suitable animation. Possible animations are, for example, the handing over of a present, laughter, anger, etc., which are allocated to the ComBOT™ 13 which represents user A and which are sent to the selected communication partner B, with the result that the corresponding ComBOT™ 13 allocated to the current user selecting the animation executes the animation.

The structure of the animotion-selection menu 40 is substantially similar to that of the selection menu 20 for the ComBOT™ images, wherein the animation is executed once the mouse pointer moves over one of the ComBOT™ images shown there. The provided animations can be generally valid, with the result that they can be executed regardless of the ComBOT™ image used by the current user, i.e., with any ComBOT™ image, or can also be carried out with only a few specific or only one ComBOT™ image 30.

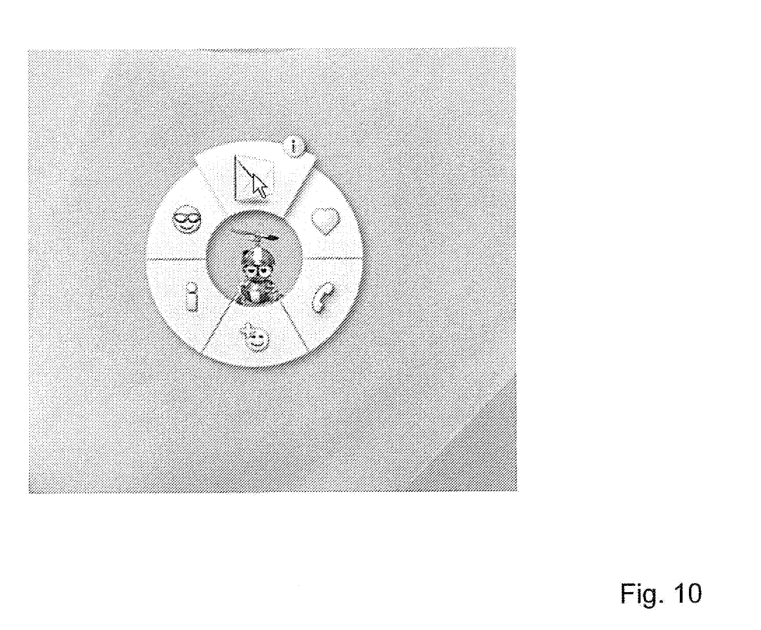

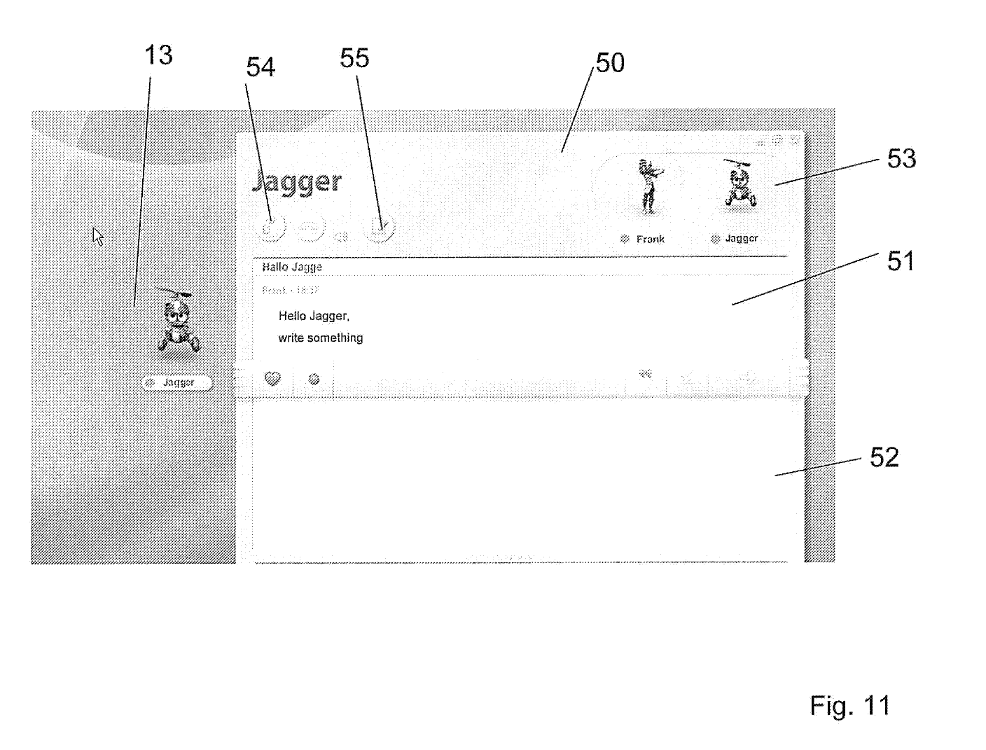

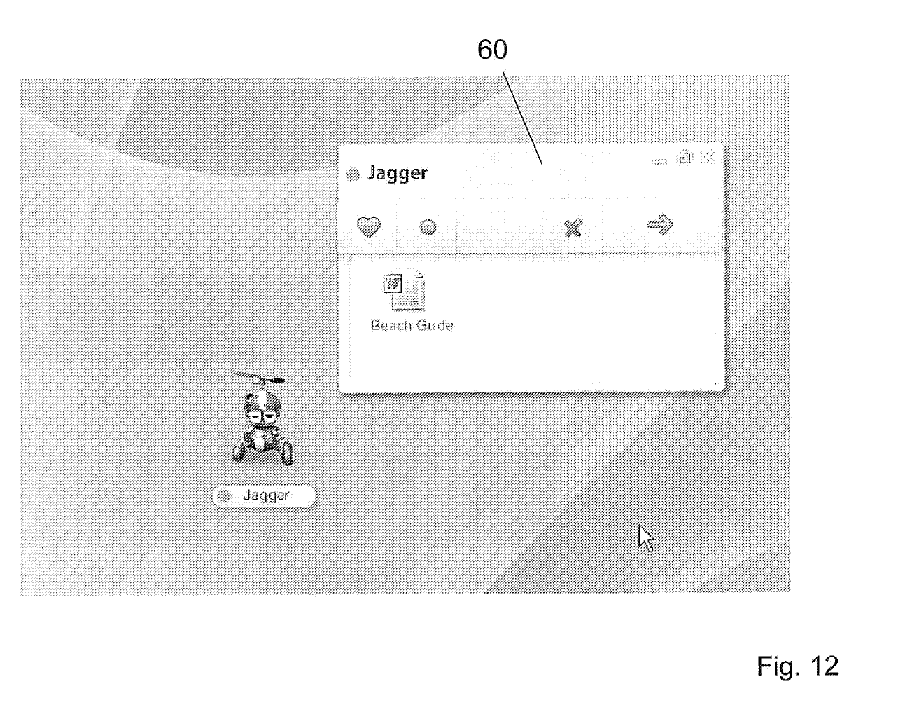

Upon selection of a segment 15 of the ComBOT™ menu 14 in which the selection element 16 is displayed as an envelope (see FIG. 10), a communication window 50 is opened with which the current user can communicate with the communication partner via, for example, an IM (Instant Messenger) connection. This is shown in FIG. 11. For this purpose, the communication window 50 is designed in two parts and shows in a first subwindow 51 which represents a conversation area the texts written by the current user and the communication partner. In a second subwindow 52 which represents an input area, the current user can compose messages which he can send by pressing the “Enter” key, and which are then displayed in the first subwindow 51 of both the current user and the communication partner to whom the written text message is being transmitted. Entries from the communication partner are likewise displayed in the conversation area. Subwindows 51 and 52 are separated by a displaceable bar or slider on which yet further operating elements can be located. The communication window 50 can furthermore have an area in which a history of the most recently conducted IM discussions is listed.

The communication window 50 can furthermore have an area in which a history of the most recently conducted IM discussions is listed. The history is a listing of communication or conversation already conducted and includes all the events or sections of the previously conducted communication, i.e., exchange of messages, text, images, documents, etc. both in real time or virtual-real time and also time-shifted. The system of the present invention supports and integrates all types of communication, with the result that the customary distinctions between synchronous and asynchronous communication, such as e.g., Instant Messaging or e-mail, do not occur here. The users can communicate with each other at any time and by multimedia, without having to be concerned about the transmission method, online presence of the partner or similar.

Furthermore, both the ComBOT™ image of the current user and the ComBOT™ image of communication partner B can be displayed in one arena area 53 of the communication window. The current user A can select a suitable or matched ComBOT™ image for every possible communication partner with whom the current user A is or can be connected, with the result that the current user A is displayed to different communication partners with different ComBOT™ images.

Furthermore, the communication window 50 can have a telephone selection element 54 to establish a telephone connection, and a file selection element to attach a flagged message or attach a file, so that further data, which can be sound, image or video data for example, can supplement the text message.

A further function which the client program makes available is that files can be dragged onto the ComBOT™ 13 on the background surface or desktop 10 of the screen by drag-and-drop. The file symbol is selected and, with mouse button depressed, guided over the ComBOT™ 13 and the mouse button released there. The file allocated to the file symbol is then sent immediately to the communication partner allocated to the ComBOT™ 13.

The result of “dragging & dropping” the file symbol onto the ComBOT™ 13 of the communication partner is that, as shown in FIG. 12 a second communication window 60 is automatically opened. However, the second communication window 60 is smaller but likewise allows a text input which can be sent to the communication partner allocated to the ComBOT™ 13 by pressing the Enter key. In this embodiment, the second communication window 60 has no first subwindow to display the previously written texts, but is tailored to the core functionalities or core areas for the “transmission via drag & drop” function applied here. In particular, after inputting a text and then pressing the “Send” key (arrow key), the second communication window can automatically be closed and the file and the input text sent to the communication partner.

After the file symbol is dropped onto the ComBOT™ 13, the second communication window 60 is opened and a small presentation, e.g., a preview of an image or a video sequence, is already displayed in the second communication window, so that the current user can ensure that he has “dropped” onto the ComBOT™ 13 the correct file which is to be sent to the allocated communication partner.

Generally speaking, the display of communication windows, application windows or operating windows can be linked to the different functions which are called in the client program. In the client program, the size and the functions available therein of the communication window can be different, depending on the type of function called. The communication window, application window, or operating window displayed in each case is thus precisely tailored to the function triggered or application selected by the user. This is advantageous because, when sending a file, often only a one-off very short text communication from the current user is needed to comment when required on the file. On the other hand, if the current user consciously chooses an IM connection, he usually has it in mind to carry out a lengthier communication with the allocated communication partner.

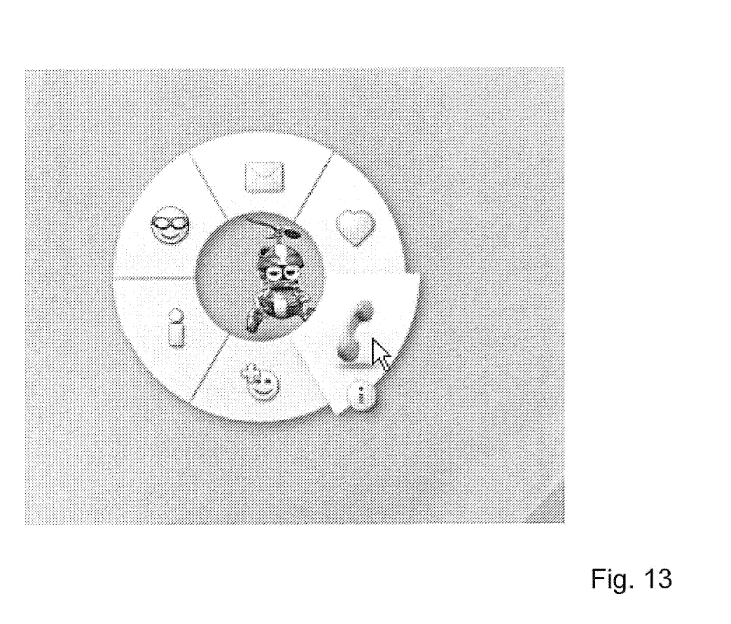

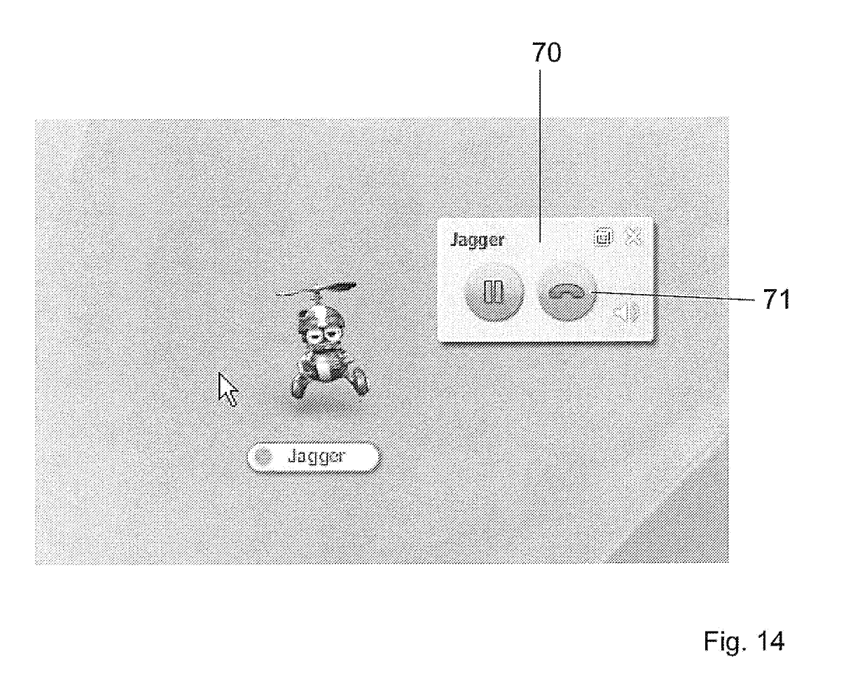

The display of a communication window, application window or operating window, subsumed under the term communication window, or window for short, can furthermore also be made dependent on what type of communication the current user selects. Thus for example if the corresponding segment 15 of the ComBOT™ menu 14 is selected to establish a telephone connection (see FIG. 13), a third communication window 70 (see FIG. 14) can simultaneously be opened which is merely provided with operating elements to change settings relating to the called program function. As the telephone connection represents the main communication level, no space for making entries is required here, with the result that a communication window provided merely with the operating elements 71 is sufficient. On the other hand, when establishing an IM communication connection, as described above, a large first communication window is displayed.

Furthermore, the size of the communication window and the functions that can be selected therein can be executed depending on the operating function with which the user selects or starts the application. The operating function can be specified, for example, with a mouse click, with a drag & drop, or with a mouse movement over a specific area of the display interface such as a mouseover. In this way, the user can determine the size and functionality of the communication window by choosing how the desired function of the client program is called. Thus the same function can be called in different ways, with the result that in addition to executing the corresponding function a communication window dependent on the type of call is displayed.

Alternatively or in addition, the size of the communication window and the functions that can be selected therein can be determined depending on whether a specific function of the client program is selected or started by the current user of the corresponding terminal or whether for example the communication partner connected to the current user starts a specific function of the client program at the current user via the communication connection. Thus a communication window with a specific size and with specific functions can be displayed when a call is made by the communication partner, the latter writes an e-mail and similar. The communication window opened in these cases can differ in size and functionality from those which are opened by actions of the user himself.

Furthermore, each call of a function of the client program via the ComBOT™ 13 can preferably lead to the display of a corresponding communication window, matched thereto, further specific subfunctions being selectably displayable by corresponding selection elements to execute the function. In particular, the communication windows can have subwindows for inputting and transmitting text messages by pressing a text message selection element.

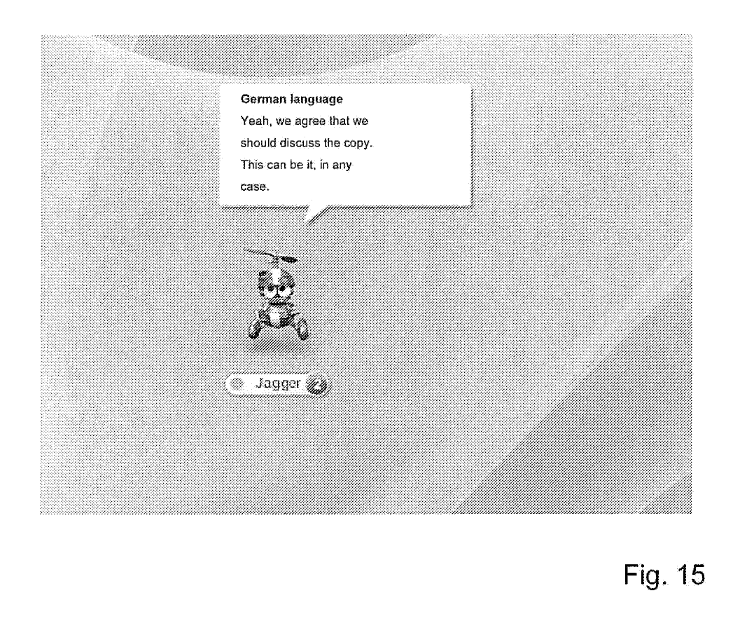

Furthermore, it is possible that when the communication partner sends a message, the message is displayed as a speech bubble (see FIG. 15) to the ComBOT™ symbol allocated to the communication partner, and furthermore the ComBOT™ symbol of the communication partner who has sent the text message executes a specific animation to attract the attention of the communication partner. A click on the speech bubble can then open a communication window which makes possible a further IM connection with the communication partner.

Additionally, there can be located in the communication window a selection element to call the animotion selection menu which makes possible the selection of an animation for its own ComBOT™ symbol. Following selection, the selected ComBOT™ image is transmitted to the communication partner, with the result that the ComBOT™ symbol allocated to the current user executes the animation in order to communicate a specific emotion or mood non-verbally.

As FIGS. 16a-d illustrate in more detail, the selection menu 14 (ComBOT™ menu) can be progressively expanded around the ComBOT™ 13 and can be spatially securely allocated to it. In a preferred embodiment of the present invention, it is only when the user clicks on the ComBOT™ 13 or there is a mouseover does the ComBOT™ menu 14 appear, very small at first, then begin to expand almost “out of nothing” as shown in FIG. 16a. The menu 14 expands spirally or spiral-shaped to form a ring enclosing the ComBOT™ and the individual segments become increasingly more visible, as illustrated in FIGS. 16b and 16c. The spiral movement is realized by a corresponding graphic animation and shown here in FIG. 16b by a symbolic arrow. The menu 14 itself has a semi-transparent appearance at least during the development phase, with the result that the user can still easily recognize the ComBOT™ . The spiral movement is concluded in the position in which the menu 14 has reached its predefinable final size and the segments are located in the predefinable normal positions, with the result that the menu 14 completely encloses the ComBOT™, as shown in FIG. 16d.

While the invention has been particularly shown and described with reference to preferred embodiments thereof, it will be understood by those skilled in the art that various changes in form and details may be made therein without departing from the spirit and scope of the invention.

What is claimed is:

1. A method for providing at least one matched communication window on a terminal of a user for communication with a communication partner, the method comprising the steps of:
displaying, based on a call of a program function, either a first communication window having a first size and a first functionality or a second communication window having a second size and a second functionality, the second size being different from the first size and the second functionality being at least partially different from the first functionality,
wherein either the first or second communication window is displayed depending on a type of communication the program function includes.

2. The method as recited in claim 1, further comprising the step of:
displaying either the first or second communication window depending on whether the called program function is a real-time application.

3. The method as recited in claim 1, wherein:
the first communication window comprises:
a conversation area in which at least one entry of the communication partner and the user is displayed; and
an input area, and
the second communication window comprises:
an input area; and
no conversation area.

4. The method as recited in claim 2, wherein the real-time application is at least one of an Instant Messaging application and a telephony application.

5. The method as recited in claim 1, wherein the type of communication comprises at least one of a voice communication, an image communication, a text communication, a file-transfer communication, a non-verbal communication, and an animotion communication.

6. The method as recited in claim 1, wherein the displaying step further comprises displaying the first or second communication window depending on an operating function with which a selection of the program function is executed.

7. The method as recited in claim 6, wherein the operating function comprises at least one of a mouse movement, a mouse click, a drag & drop operation, and a mouseover operation.

8. The method as recited in claim 1, wherein the displaying step comprises:
displaying the first or second communication window depending on whether the call of the program function is executed by the user or a further user connected to the terminal of the user.

9. The method as recited in claim 1, further comprising the step of:
displaying, depending on the call of the program function, a third communication window having at least one operating element for changing settings relating to the called program function.

10. A device for providing at least one matched communication window on a terminal of a user for communication with a communication partner, the device comprising:
a display unit;
a displaying unit operable to display, based on a call of a program function, either a first communication window having a first size and a first functionality or a second communication window having a second size and a second functionality, the second size being different from the first size and the second functionality being at least partially different from the first functionality,
wherein either the first or second communication window is displayed depending on a type of communication the program function includes.

11. The device as recited in claim 10, wherein the displaying unit is operable to display either the first or second communication window depending on whether the called program function is a real-time application.

12. The device as recited in claim 10, wherein:
the first communication window comprises:
a conversation area in which at least one entry of the communication partner and the user is displayed; and
an input area, and
the second communication window comprises:
an input area; and
no conversation area.

13. The device as recited in claim 11, wherein the real-time application is at least one of an Instant Messaging application and a telephony application.

14. The device as recited in claim 10, wherein the type of communication comprises at least one of a voice communication, an image communication, a text communication, a file-transfer communication, a non-verbal communication, and an animotion communication.

15. The device as recited in claim 11, wherein the displaying unit is further operable to display the first or second communication window depending on an operating function with which a selection of the program function is executed.

16. The device as recited in claim 15, wherein the operating function comprises at least one of a mouse movement, a mouse click, a drag & drop operation, and a mouseover operation.

17. The device as recited in claim 10, wherein the displaying unit is further operable to display the first or second communication window depending on whether the call of the program function is executed by the user or a further user connected to the terminal of the user.

18. The device as recited in claim 10, wherein the display unit is further operable to display a third communication window having at least one operating element for changing settings relating to the called program function, depending on the call of the program function.

19. A computer-readable medium encoded with a computer program providing at least one matched communication window on a terminal of a user for communication with a communication partner, the computer program configured to:
display, based on a call of a program function, either a first communication window having a first size and a first functionality or a second window having a second size and a second functionality, the second size being different from the first size and the second functionality being at least partially different from the first functionality,
wherein either the first or second communication window is displayed depending on a type of communication the program function includes.

20. The computer-readable medium as recited in claim 19, wherein either the first or second communication window is displayed depending on whether the called program function is a real-time application.
